(19) United States
(12) Patent Application Publication
(10) Pub. No.: US 2015/0183990 A1
(43) Pub. Date: Jul. 2, 2015

(54) MELT-PROCESSABLE POLYAMIDE COMPOSITIONS HAVING SILICONE-CONTAINING POLYMERIC PROCESS ADDITIVE

(71) Applicant: 3M INNOVATIVE PROPERTIES COMPANY, St. Paul, MN (US)

(72) Inventors: Maria P. Dillon, Minneapolis, MN (US); Claude Lavallee, Maplewood, MN (US)

(73) Assignee: 3M INNOVATIVE PROPERTIES COMPANY, St. Paul, MN (US)

(21) Appl. No.: 14/407,043

(22) PCT Filed: May 23, 2013
(86) PCT No.: PCT/US2013/042477

§ 371 Date: Dec. 10, 2014

Related U.S. Application Data
(60) Provisional application No. 61/658,203, filed on Jun. 11, 2012.

(51) Int. Cl. C08L 77/02

(52) U.S. Cl. CPC C08L 77/02; C08L 2205/06; C08L 2205/03

(57) ABSTRACT

Disclosed are a composition comprising from 50 to 99.99 weight percent based on the total weight of the composition of a melt-processable thermoplastic polyamide polymer; and a silicon-containing polymeric process additive; wherein the silicon-containing polymeric process additive is present in an amount of from 0.01% to 5.0% by weight based on the total weight of the composition, and an article made from the composition.

### TECHNICAL FIELD

Melt-processable polyamide compositions and articles made using melt-processable compositions.

### BACKGROUND

Siloxanes are known to be effective polymer processing additives (PPAs). Low molecular weight polydimethyl silicone (PDMS) PPAs were reported as early as 1985 (see U.S. Pat. No. 4,535,113). Further, high molecular weight siloxane PPAs have more recently become available, for instance, from Dow Corning. The efficacy of these materials, however, is generally inferior to fluoroelastomer PPAs such as FX-9613 (available from 3M Company). Further, the tacky nature of such siloxane PPAs can make them difficult to handle and as such they are only provided as concentrates.

Siloxane block copolymers have also demonstrated efficacy as PPAs. For instance, 3M has developed a siloxane-polyamide PPA, and siloxane-polyurea block copolymers (SPU) are available from Wacker. These materials are thermoplastic and generally are more easily handled. Although effective as PPAs, they are typically less efficacious than fluoroelastomer based PPAs.

In practice, PPAs are added to melt-processable thermoplastic polymers in order to improve their characteristics, for instance, in blow molding or injection molding.

### SUMMARY

In one aspect, the present description relates to a composition comprising from 50 to 99.99 weight percent based on the total weight of the composition of a melt-processable thermoplastic polyamide polymer; and a silicone-containing polymeric process additive;

wherein the ratio of the silicone-containing polymeric process additive is present in an amount of from 0.01% to 5.0% by weight based on the total weight of the composition.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### DETAILED DESCRIPTION

Polyamides include naturally occurring and synthetically prepared materials that contain amides joined by peptide bonds. Polyamides are commonly used in textiles, automotives, carpet, and sportswear, due to their extreme durability and strength. These materials are commonly completely insulating, and generate static electricity (which has lead to the common practice of incorporating anti-static fillers such as silver or carbon black).

With processed plastics, processing conditions play a key role in the energy consumption of manufacturing processes and the quality of the finished articles produced. Further, the incorporation of fillers can impose difficulties in the processing (e.g., extrusion molding, blow molding, and the like). Accordingly, there remains a need to find process additives that can aid in the processing of plastics, in particular polyamides, to improve processing conditions (e.g., energy consumption) and/or quality of the resulting finished articles.

Traditional process additives such as fluoroelastomers, which find wide use in the processing of hydrocarbon polymers, can be detrimentally reactive with polyamides. Accordingly, traditional solutions to improve processability of melt-processable thermoplastic hydrocarbon polymers may not be suitable for use with polyamides.

The present inventors have found, however, that silicone-containing process additives may, in some embodiments, improve the processability of polyamide polymers while at the same time remaining resistant to detrimental reactivity with polyamide polymers. Accordingly, in one aspect, the present description relates to a composition comprising from 50 to 99.99 weight percent based on the total weight of the composition of a melt-processable thermoplastic polyamide polymer. The composition further comprises a silicone-containing polymeric process additive. The silicone-containing polymeric process additive is present in an amount of from 0.01% to 5.0% by weight based on the total weight of the composition.

In some embodiments, the silicone-containing process additive is a silicone-polyoxamide process additive.

### DEFINITIONS

The term “aralkyl” refers to a monovalent group of formula —R^{a}—Ar where R^{a} is an alkylene and Ar is an aryl group. That is, the aralkyl is an alkyl substituted with an aryl.

The term “alkaryl” refers to a monovalent group of the formula —Ar—R^{a} where R^{a} is an alkylene and Ar is an aryl group. That is, the alkaryl is an aryl substituted with one or more alkyl.

The term “aralkylene” refers to a divalent group of formula —R^{a}—Ar^{a}— where R^{a} is an alkylene and Ar^{a} is an arylene (i.e., an alkylene is bonded to an arylene).

The term “alkarylene” refers to a divalent group of formula —Ar^{a}—R^{a}— where R^{a} is an alkylene and Ar^{a} is an arylene (i.e., an arylene is bonded to an alkylene).

The term “polydiorganosiloxane” refers to a divalent segment of formula

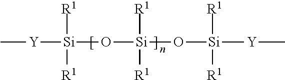

where each R¹ is independently an alkyl, haloalkyl, aralkyl, alkenyl, aryl, or aryl substituted with an alkyl, alkoxy, or halo; each Y is independently an alkylene, aralkylene, or a combination thereof; and subscript n is independently an integer of 0 to 1500.

### Polyamide Polymer

Polyamide polymers described herein may generally be thermoplastic materials, or materials that flow when heated sufficiently above their glass transition point and become solid when cooled. They may also have elastomeric properties. The polyamide polymers include, but are not limited to, hot melt processable thermoplastic polymers (which may be elastomeric or non-elastomeric).

Polyamide polymers as described herein contain monomers of amides joined by peptide bonds. Suitable polymers may be naturally occurring or may be synthetic in nature (i.e., non-natural). Examples of naturally occurring polyamides include proteins such as wool and silk. Synthetic polyamides include those made through step-growth polymerization or solid-phase synthesis. Examples of synthetic polyamides include nylons, aramids, and sodium poy(aspartate).

The polyamide polymer may be solvent or melt mixed with the thermoplastic silicone-based PPA component(s). The polyamide polymer may comprise other additives, fillers, and the like, however, such additives are not a thermoplastic silicone-based PPA compound of Formulas I, and II.

At use temperature the mixtures generally have at least two domains, one discontinuous and the other continuous, because of the general immiscibility of the thermoplastic silicone-based PPA component with the polyamide polymer. Of course, the mixture may contain more than one thermoplastic silicone-based PPA component and more than one polyamide polymer.

Polyamides include aliphatic polyamides, wherein the main chain contains primarily aliphatic groups. Examples of such polyamides include those known in the industry as PA 6 and PA 66 (available under the tradename “Nylon” from DuPont).

Polyamides also include polypthalamides, wherein the main chain contains primarily semi-aromatic groups. Examples of such polyamides include those known in the industry as PA 6T (preparable from hexamethylenediamine and terephthalic acid and available under the tradename “Trogamid” from Evonik Industries or under the tradename “Amodel” from Solvay).

Further examples of polyamides include aramides (from “aromatic polyamides”), wherein the main chain contains primarily aromatic groups. Examples of such polyamides include copolymers of paraphenylenediamine and terephthalic acid. Commercially available examples include those available under the tradenames “Kevlar” and “Nomex” from DuPont; “Teijinconex”, “Twaron” and “Technora” from Teijin; and “Kermel” from Kermel.

Specific examples include homopolymers such as [NH—(CH₂)₅—CO]ₙ, made from ε-caprolactam; and [NH—(CH₂)₆—NH—CO—(CH₂)₄—CO]ₙ, made from hexamethylenediamine and adiptic acid; copolymers such as [NH—(CH₂)₆—NH—CO—(CH₂)₄—CO]ₙ—[NH—(CH₂)₅—CO]ₘ, made from caprolactam, hexamethylenediamine, and adipic acid; and [NH—(CH₂)₆—NH—CO—(CH₂)₄—CO]ₙ—[NH—(CH₂)₆—NH—CO—(CH₂)₈—CO]ₘ, made from hexamethylene diamine, adipic acid, and sebacic acid.

Polyamide polymers can be generally classified by their crystallinity. High crystallinity semi-crystalline polyamide polymers include those available commercially as PA46 and PA 66. Low crystallinity semi-crystalline polyamide polymers include PA mXD6, made from m-xylylenediamine and adipic acid. Amorphous polyamide polymers include PA 61, made from hexamethylenediamine and isophthalic acid.

According to the above-described classifications, for instance, PA 6 is an aliphatic semi-crystalline homopolyamide polymer.

The polyamide polymer may be present in the compositions described herein in a major amount. That is, the polyamide polymer may be present in an amount of from 50 to 99.99 percent by weight based on the total weight of the composition. More specifically, the polyamide polymer may be present in a weight percent of from 95 wt % to 99.99 wt % based on the total weight of the composition.

### Silicone-Containing Polymeric Process Additive

Various silicone-containing PPAs are useful in the compositions presently disclosed. Such silicone-containing PPAs may be thermoplastic. Silicone-containing PPAs may be polydiorganosiloxane polyamide polymers, or may include silicone-polyurethane polymers.

Thermoplastic silicone-containing polymer process additive components useful in the present disclosure may have a molecular weight greater than 25,000 g/mol, greater than 50,000 g/mol, and even greater than 100,000 g/mol. These silicone-containing PPA's include linear, polydiorganosiloxane polyamide block copolymers, polydiorganosiloxane urethane-containing copolymers, and the like. Silicone-containing PPA's presently disclosed are substantially free of fluoropolymers, siloxanes and any other process additives that are not “hot melt processable” per se (by not “hot melt processable” in this context, it is meant that such materials are fluidic polymers with very low glass transition (Tg) values, and flow at room temperature and above without the need for elevated temperatures).

A linear, polydiorganosiloxane polyamide block copolymer useful in compositions of the present disclosure contains at least two repeat units of Formula I:

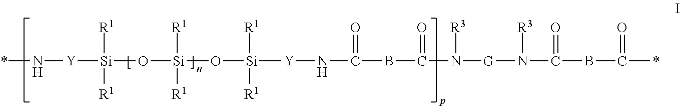

In this formula, each R¹ is independently an alkyl, haloalkyl, aralkyl, alkenyl, aryl, or aryl substituted with an alkyl, alkoxy, or halo. Each Y is independently an alkylene, aralkylene, or a combination thereof. Subscript n is independently an integer of 0 to 1500 and subscript p is an integer of 1 to 10. Each group B is independently a covalent bond, an alkylene of 4-20 carbons, an aralkylene, an arylene, or a combination thereof. When each group B is a covalent bond, the polydiorganosiloxane polyamide block copolymer of Formula I is referred to as a polydiorganosiloxane polyoxamide block copolymer.

Group G is a divalent group that is the residue unit that is equal to a diamine of formula R³HN-G-NHR³ minus the two —NHR³ groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine or the like). Each asterisk (*) indicates a site of attachment of the repeat unit to another group in the copolymer such as, for example, another repeat unit of Formula I.

Suitable alkyl groups for R¹ in Formula I typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (i.e., it may be an alkaryl group) (the alkyl group may be, e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group with 1 to 10 carbon atoms and an aryl group with 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl where an alkylene is bonded to a phenyl group).

In some embodiments, in some repeat units of Formula I, at least 40 percent, and preferably at least 50 percent, of the R¹ groups are phenyl, methyl, or combinations thereof. For example, at least 60 percent, at least 70 percent, at least 80 percent, at least 90 percent, at least 95 percent, at least 98 percent, or at least 99 percent of the R¹ groups can be phenyl, methyl, or combinations thereof. In some embodiments, in some repeat units of Formula I, at least 40 percent, and preferably at least 50 percent, of the R¹ groups are methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo.

Each Y in Formula I is independently an alkylene, aralkylene, alkarylene or a combination thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group with 6 to 12 carbon atoms bonded to an alkylene group with 1 to 10 carbon atoms. In some exemplary aralkylene groups, the arylene portion is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene group. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

Each subscript n in Formula I is independently an integer of 0 to 1500. For example, subscript n can be an integer up to 1000, up to 500, up to 400, up to 300, up to 200, up to 100, up to 80, up to 60, up to 40, up to 20, or up to 10. The value of n is often at least 1, at least 2, at least 3, at least 5, at least 10, at least 20, or at least 40. For example, subscript n can be in the range of 40 to 1500, 0 to 1000, 40 to 1000, 0 to 500, 1 to 500, 40 to 500, 1 to 400, 1 to 300, 1 to 200, 1 to 100, 1 to 80, 1 to 40, or 1 to 20.

The subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1to 4.

Group G in Formula I is a residual unit that is equal to a diamine compound of formula R³HN-G-NHR³ minus the two amino groups (i.e., —NHR³ groups). The diamine can have primary or secondary amino groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine). In most embodiments, R³ is hydrogen or an alkyl. In many embodiments, both of the amino groups of the diamine are primary amino groups (i.e., both R³ groups are hydrogen) and the diamine is of formula H₂N-G-NH₂.

In some embodiments, G is an alkylene, heteroalkylene, polydiorganosiloxane, arylene, aralkylene, alkarylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof. Suitable polydiorganosiloxanes include the polydiorganosiloxane diamines of Formula III, which are described below, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. Some exemplary alkarylene groups are alkylene-phenylene where the alkylene having 1 to 10 carbon atoms, 1 to 8 carbon atoms, 1 to 6 carbon atoms, or 1 to 4 carbon atoms is bonded to an phenylene. As used herein with reference to group G, “a combination thereof” refers to a combination of two or more groups selected from an alkylene, heteroalkylene, polydiorganosiloxane, arylene, aralkylene, and alkarylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

In some embodiments, the polydiorganosiloxane polyamide is a polydiorganosiloxane polyoxamide. The polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

The polydiorganosiloxane polyamide is a block copolymer and can be an elastomeric material. Unlike many of the known polydiorganosiloxane polyamides that are generally formulated as brittle solids or hard plastics, the polydiorganosiloxane polyamides can be formulated to include greater than 50 weight percent polydiorganosiloxane segments based on the weight of the copolymer. The weight percent of the diorganosiloxane in the polydiorganosiloxane polyamides can be increased by using higher molecular weight polydiorganosiloxanes segments to provide greater than 60 weight percent, greater than 70 weight percent, greater than 80 weight percent, greater than 90 weight percent, greater than 95 weight percent, or greater than 98 weight percent of the polydiorganosiloxane segments in the polydiorganosiloxane polyamides. Higher amounts of the polydiorganosiloxane can be used to prepare elastomeric materials with lower modulus while maintaining reasonable strength.

Some of the polydiorganosiloxane polyamides can be heated to a temperature up to 200° C., up to 225° C., up to 250° C., up to 275° C., or up to 300° C. without noticeable degradation of the material. For example, when heated in a thermogravimetric analyzer in the presence of air, the copolymers often have less than a 10 percent weight loss when scanned at a rate 50° C. per minute in the range of 20° C. to 350° C. Additionally, the copolymers can often be heated at a temperature such as 250° C. for 1 hour in air without apparent degradation as determined by no detectable loss of mechanical strength upon cooling.

Certain embodiments of the copolymeric material of Formula I can be optically clear. As used herein, the term “optically clear” refers to a material that is clear to the human eye. An optically clear copolymeric material often has a luminous transmission of at least 90 percent, a haze of less than 2 percent, and opacity of less than about 1 percent in the 400 to 700 nm wavelength range. Both the luminous transmission and the haze can be determined using, for example, the method of ASTM-D 1003-95.

Additionally, certain embodiments of the copolymeric material of Formula I can have a low refractive index. As used herein, the term “refractive index” refers to the absolute refractive index of a material (e.g., copolymeric material) and is the ratio of the speed of electromagnetic radiation in free space to the speed of the electromagnetic radiation in the material of interest. The electromagnetic radiation is white light. The index of refraction is measured using an Abbe refractometer, available commercially, for example, from Fisher Instruments of Pittsburgh, Pa. The measurement of the refractive index can depend, to some extent, on the particular refractometer used. The copolymeric material usually has a refractive index in the range of 1.41 to 1.60.

The polydiorganosiloxane polyamides are soluble in many common organic solvents such as, for example, toluene, tetrahydrofuran, dichloromethane, aliphatic hydrocarbons (e.g., alkanes such as hexane), or mixtures thereof.

Silicone-polyurethane copolymers (SPU) are not particularly limited, and include, for instance, block copolymers comprising silicone blocks and diamide blocks. At points herein the term silicone-polyurea may be used interchangeable with silicone-polyurethane.

Diamide blocks may have two amide functional groups (—NHCO—) attached to a divalent organic radical (such as alkyl groups, cycloalkyl groups, and aryl groups, containing from 1 to 30 carbon atoms). Non-limiting examples of diisocyanate compounds from which diamide groups may be derived are ethylene diisocyanate, 1,6-hexylene diisocyanate, 1,12-dodecylene diisocyanate, 4,4′-diphenylmethane diisocyanate, 3,3′-dimethoxy-4,4′-diphenylmethane diisocyanate, 3,3′-dimethyl-4,4′-diphenylmethane diisocyanate, 4,4′-diphenyl diisocyanate, toluene-2,6,-diisocyanate, mixtures of toluene-2,6-diisocyanate and toluene-2,4-diisocyanate, 1,4-cyclohexylene diisocyanate, 4,4′-dicyclohexylmethane diisocyanate, 3,3′-diphenyl-4,4′-biphenylene diisocyanate, 4,4′-biphenylene diisocyanate, 2,4-diisocyanatodiphenylether, 2,4-dimethyl-1,3-phenylene diisocyanate, 4,4′-diphenylether diisocyanate, isophorone diisocyanate, and the like, and mixtures of any of the foregoing.

Silicone blocks include those having the general formula (Si(R²)₂O—) wherein R² is an organic group selected from the group consisting of substituted and unsubstituted alkyl groups, cycloalkyl groups, and aryl groups, each R² group being the same or different as the other connected to a given Si atom and having from 1 to 18 carbon atoms. Non-limiting examples include dimethylsilicones, diethylsilicones, and diphenylsilicones.

Polydiorganosiloxane urethane-containing copolymers (a subset of the class of SPU materials) useful in compositions of the present disclosure contain soft polydiorganosiloxane units, hard polyisocyanate residue units, terminal groups and optionally soft and/or hard organic polyamine residue units. Some polydiorganosiloxane urea-containing copolymers are commercially available under the trade designation “Geniomer 140” available from Wacker Chemie AG, Germany. The polyisocyanate residue is the polyisocyanate minus the —NCO groups, the organic polyamine residue is the organic polyamine minus the —NH groups, and the polyisocyanate residue is connected to the polydiorganosiloxane units or organic polyamine residues by urea linkages. The terminal groups may be non-functional groups or functional groups depending on the purpose of the polydiorganosiloxane urea segmented copolymer.

The polydiorganosiloxane urethane containing copolymers useful in presently disclosed compositions contains at least two repeat units of Formula II

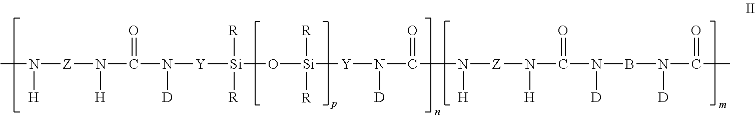

In this Formula II each R is a moiety that independently is an alkyl moiety preferably having about 1 to 12 carbon atoms and may be substituted with, for example, trifluoroalkyl or vinyl groups, a vinyl radical or higher alkenyl radical preferably represented by the formula —R² (CH₂)ₐCH—CH₂ wherein R² is —(CH₂)_{b}— or —(CH) CH—CH— and a is 1, 2 or 3; b is 0, 3 or 6; and c is 3, 4 or 5, a cycloalkyl moiety having about 6 to 12 carbon atoms and may be substituted with alkyl, fluoroalkyl, and vinyl groups, or an aryl moiety preferably having about 6 to 20 carbon atoms and may be substituted with, for example, alkyl, cycloalkyl, fluoroalkyl and vinyl groups or R is a perfluoroalkyl group as described in U.S. Pat. No. 5,028,679, wherein such description is incorporated herein by reference, a fluorine-containing group, as described in U.S. Pat. No. 5,236,997, wherein such description is incorporated herein by reference, or a perfluoroether-containing group, as described in U.S. Pat. Nos. 4,900,474 and 5,118,775, wherein such descriptions are incorporated herein by reference; preferably at least 50% of the R moieties are methyl radicals with the balance being monovalent alkyl or substituted alkyl radicals having 1 to 12 carbon atoms, alkenylene radicals, phenyl radicals, or substituted phenyl radicals; each Z is a polyvalent radical that is an arylene radical or an aralkylene radical preferably having from about 6 to 20 carbon atoms, an alkylene or cycloalkylene radical preferably having from about 6 to 20 carbon atoms, preferably Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylene, 1,6-hexamethylene, 1,4-cyclohexylene, 2,2,4-trimethylhexylene and mixtures thereof; each Y is a polyvalent radical that independently is an alkylene radical preferably having 1 to 10 carbon atoms, an aralkylene radical or an arylene radical preferably having 6 to 20 carbon atoms; each D is independently selected from the group consisting of hydrogen, an alkyl radical of 1 to 10 carbon atoms, phenyl, and a radical that completes a ring structure including B or Y to form a heterocycle; B is a polyvalent radical selected from the group consisting of alkylene, aralkylene, cycloalkylene, phenylene, polyalkylene oxide, including for example, polyethylene oxide, polypropylene oxide, polytetramethylene oxide, and copolymers and mixtures thereof; m is a number that is 0 to about 1000; n is a number that is equal to or greater than 1; and p is a number that is about 5 or larger, preferably about 15 to 2000, more preferably about 30 to 1500.

In the use of polyisocyanates (Z is a radical having a functionality greater than 2) and polyamines (B is a radical having a functionality greater than 2), the structure of Formula I will be modified to reflect branching at the polymer backbone. In the use of endcapping agents, the structure of Formula II will be modified to reflect termination of the polydiorganosiloxane urea chain.

The silicone-containing process additives described herein may be present in the described compositions in a weight percent of from 0.01 wt % to 5.0 wt %, based on the total weight of the composition. More particularly, the silicone-containing process additive may be present in a weight percent of from 0.01 wt % to 0.5 wt 5 based on the total weight of the composition.

### Methods of Making Polydiorganosiloxane Polyamide Copolymers

The linear block copolymers having repeat units of Formula I can be prepared, for example, as discussed in WO 2010/077480. Further, polydiorganosiloxane urea containing copolymers may be prepared, also as discussed in WO 2010/077480.

### Synergist

In the present description, suitable synergists (sometimes also referred to in the field as “interfacial agents”), may be included into either a masterbatch or into extrudable compositions. By interfacial agent is meant a thermoplastic polymer which is characterized by (1) being in the liquid state (or molten) at the extrusion temperature; (2) having a lower melt viscosity than both the polyamide polymer and the process additive; and (3) freely wets the surface of the process additive particles in the compositions.

Examples of such synergists include, but are not limited to i) a silicone-polyether copolymer; ii) an aliphatic polyester such as polybutylene adipate), poly(lactic acid) and polycaprolactone polyesters (preferably, the polyester is not a block copolymer of a dicarboxylic acid with a poly(oxyalkylene) polymer); iii) aromatic polyesters such as phthalic acid diisobutyl ester; iv) polyether polyols (preferably, not a polyalkylene oxide) such as poly(tetramethylene ether glycol); v) amine oxides such as octyidimethyl amine oxide; vi) carboxylic acids such as hydroxy-butanedioic acid; vii) fatty acid esters such as sorbitan monolaurate and triglycerides; and vii) poly(oxyalkylene) polymers. As used herein, the term “poly(oxyalkylene) polymers” refers to those polymers and their derivatives that are described in U.S. Pat. No. 4,855,360. Such polymers include polyethylene glycols and their derivatives.

One embodiment of aliphatic polyester synergist is a polycaprolactone having a number average molecular weight in the range of from 1000 to 32000, or more specifically from 2000 to 4000.

Another embodiment of synergist includes poly(oxyalkylene) polymers, such as poly(ethylene) glycol polymers having a number average molecular weight in the range of from 1000 to 12,000, or more specifically from 5000 to 10,000.

The synergist is a relatively low molecular weight ingredient which, for a particular system of process additive and polyamide polymer, may improve the efficacy of the process additive. The synergist may be introduced at any point up to and including the final melt shaping process. In some instances, the process additive and synergist may be combined in a masterbatching step where both ingredients are present at high concentration (i.e., at greater than or equal to 1 wt. %, based on the total weight of the masterbatch).

In specific embodiments, the synergist may be present in an amount of from 10 wt % to 70 wt % based on the total amount of synergist and process additive, more specifically from 10 wt % to 50 wt %, and even more specifically, from 10 wt % to 30 wt %. As can be seen in the Examples, applicants have found that such amounts of synergist with the process additive can give superior results in melt-fracture elimination at one hour.

### Other Additives

Functional components, tackifiers, plasticizers, and other property modifiers may be incorporated in the polyamide polymer, the process additive, or both of the components of the presently disclosed compositions. Preferred optional additives generally are not hot melt processable. That is, they do not melt and flow at the temperatures at which the polyamide polymer and the process additive component melt and flow.

Functional components include, for example, antistatic additives, ultraviolet light absorbers (UVAs), dyes, colorants, pigments, antioxidants, slip agents, low adhesion materials, conductive materials, abrasion resistant materials, optical elements, dimensional stabilizers, adhesives, tackifiers, flame retardants, phosphorescent materials, fluorescent materials, nanoparticles, anti-graffiti agents, dew-resistant agents, load bearing agents, silicate resins, fumed silica, glass beads, glass bubbles, glass fibers, mineral fibers, clay particles, organic fibers, metal particles, and the like.

Such optional additives can be added in amounts up to 100 parts per 100 parts of the sum of the polyamide polymer and the process additive, provided that if and when incorporated, such additives are not detrimental to the function and functionality of the final composition and/or articles derived therefrom. Other additives such as light diffusing materials, light absorptive materials and optical brighteners, flame retardants, stabilizers, antioxidants, compatibilizers, antimicrobial agents such as zinc oxide, electrical conductors, thermal conductors such as aluminum oxide, boron nitride, aluminum nitride, and nickel particles, including organic and/or inorganic particles, or any number or combination thereof, can be blended into these systems.

The functional components discussed herein may also be incorporated into the process additive provided such incorporation does not adversely affect any of the resulting products to an undesirable extent.

### Processes of Making Compositions and Constructions

The presently disclosed compositions and constructions can be made by solvent-based processes known to the art, by a solventless process, or by a combination of the two.

One skilled in the art can expect the optimum mixture to be a function of the architecture and ratios of the process additive, the architecture and ratios of the polyamide polymer, and whether any functional components, additives, or property modifiers are added.

Such processes, variations, and considerations are discussed, for example, in WO 2010/077480.

Various articles can be made using the disclosed compositions. These articles can be made by various methods, including, melt mixing the polyamide polymer and the process additive to form a composition, and molding the composition (e.g., by blow molding, injection molding, and the like). Melt mixing can done by batch blending or extrusion.

These articles include blow molded films, injection molded tubes, bottles tube fittings, and the like. Articles made using the disclosed compositions have a weight percent of the processing additive ranging from 0.01 wt % to 10 wt % based on the total weight of the article.

### EMBODIMENTS

The articles and compositions described in the present application are further represented by the following listing of embodiments.

### Embodiment 1

A composition comprising:

from 50 to 99.99 weight percent based on the total weight of the composition of a melt-processable thermoplastic polyamide polymer; and

a silicone-containing polymeric process additive;

wherein the ratio of the silicone-containing polymeric process additive is present in an amount of from 0.01% to 5.0% by weight based on the total weight of the composition.

### Embodiment 2

The composition of embodiment 1, wherein the polyamide polymer is selected from the group consisting of: a polyamide homopolymer, a polyamide co-polymer, and a combination thereof.

### Embodiment 3

The composition of embodiment 1, wherein the polyamide polymer is selected from the group consisting of: an aliphatic polyamide polymer, a semi-aromatic polyamide polymer, and an aromatic polyamide polymer.

### Embodiment 4

The composition of embodiment 3, wherein the polyamide polymer is an aliphatic polyamide polymer.

### Embodiment 5

The composition of embodiment 4, wherein the polyamide polymer is selected from the group consisting of: [NH—(CH₂)₅—CO]ₙ and [NH—(CH₂)₆—NH—CO—(CH₂)₄—CO]ₙ, where n is an integer of from 10 to 10,000.

### Embodiment 6

The composition of any of the preceding embodiments, wherein the silicone-containing polymeric process additive is a silicone-polyurethane.

### Embodiment 7

The composition of any of embodiments 1 to 5, wherein the silicone-containing process additive is a silicone-polyamide selected from the group consisting of:

a copolymer comprising at least two repeat units of Formula I:

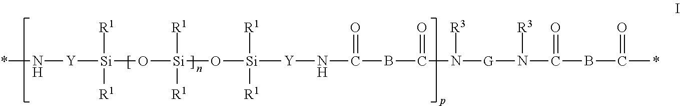

wherein each R¹ is independently selected from the group consisting of: an alkyl group, a haloalkyl group, an aralkyl group, an alkenyl group, an aryl group, an alkoxy group, and a halogen;

each Y is independently selected from the group consisting of: an alkylene group, aralkylene group, and a combination thereof;

G is a divalent group;

each B is independently selected from the group consisting of: a covalent bond, an alkylene group having from 4 to 20 carbons atoms, an aralkylene group, an arylene group, and a combination thereof; n is an integer of 0 to 1500; and p is an integer of 1 to 10; and

each R³ is independently selected from the group consisting of: an alkyl group, a haloalkyl group, an aralkyl group, an alkenyl group, an aryl group, an alkoxy group, and an alkylene group having 2 or more carbon atoms forming a heterocyclic ring that includes the R³ groups, the nitrogen atoms, and G.

### Embodiment 8

The composition of any of the preceding embodiments, wherein the silicone-containing process additive is present in a weight percent of from 0.01 wt % to 3.0 wt % based on the total weight of the composition.

### Embodiment 9

The composition of any of the preceding embodiments, wherein the silicone-containing process additive is present in a weight percent of from 0.01 wt % to 0.5 wt % based on the total weight of the composition.

### Embodiment 10

The composition of any of the preceding embodiments, further comprising a synergist.

### Embodiment 11

The composition of embodiment 10, wherein the synergist is selected from the group consisting of i) a silicone-polyether copolymer; ii) an aliphatic polyester; iii) an aromatic polyester; iv) a polyether polyol; v) an amine oxide; vi) a carboxylic acid; vii) a fatty acid ester; and vii) a poly(oxyalkylene) polymer.

### Embodiment 12

The composition embodiment 11, wherein the synergist is polyethyleneglycol.

### Embodiment 13

The composition of embodiment 10, wherein the synergist is present in an amount of from 10 wt % to 75 wt % based on the total weight of the synergist and the process additive.

### Embodiment 14

The composition of any of the preceding embodiments, further comprising an anti-static additive.

### EXAMPLES

The following examples are merely for illustrative purposes and are not meant to limit in any way the scope of the appended claims. All parts, percentages, ratios, and the like in the examples are by weight, unless noted otherwise.

### Examples

### Materials

| Acronym | Description |
|---|---|
| PA-1 | A 33 Mooney viscosity fluoroelastomer commercially |
| | available under the trade designation “FX-9613” from |
| | Dyneon LLC, Oakdale, MN. |
| PA-2 | A silicone polyoxamide polymer with a 25,000 MW |
| | siloxane block preparable according to the method |
| | described in US2008 0318065 (Sherman et al.). |
| T-1 | A LLDPE commercially available from Chevron |
| | Philips Chemicals under the trade designation |
| | ″MARFLEX 7109″ |
| T-2 | A polyamide 6 commercially available from Nylon |
| | Corporations of America (NYCOA) Manchester, NH |
| | under under the trade designation ″NYCOA NYLON |
| | 568″ |
| Zinc Stearate | A zinc stearate commercially available from Alfa Aesar, |
| | Ward Hill MA, under the stock #33238 |
| Erucamide | Added to the test resin in the form of a 5% additive |
| | concentrate (#10090) available from Ampacet |
| | Corporation, Tarrytown, NY |
| ABT-2500 | A talc antiblock commercially available from Specialty |
| | Minerals, Bethelem PA. It was added to the test resin |
| | in the form of a 60% concentrate (#101558) available |
| | from Ampacet Corporation, Tarrytown, NY |
| ANTIOXIDANT | A synergistic blend of antioxidants commercially |
| | available as ″IRGANOX B 900″ from Ciba Specialty |
| | Additives, Basel, Switzerland |

### Shear Stress Reduction Test—Polyamides

The extrusion of T-2 was performed using a Haake 90 drive with 19 mm conical counter rotating twin screw extruder (commercially available from HaakeBuchler under the trade designation “RHEOMIX TW-100”), equipped with a capillary die (L/D 15, =2.0 mm diameter×30 mm long). The extruder set points were for the 3 zones were 210° C., 250° C. and 260° C. The die was set a 260° C. The feed throat was air cooled. The twin screw was starved feed using a Ktron Feeder. The ratio of the twin-screw RPM to Feeder RPM was kept constant.

Before each test, the extruder was purged with a blend of a purge compound (commercially available from A. Schulman, Akron, Ohio under the trade designation “KC 30”) and T-1, followed by a purge with the T-1 alone. The extruder and die were then brushed clean with a brass bristle brush.

The baseline conditions were measured for the extrusion of T-2 at 3 rates. The twin-screw speed was set successively at 50, 36, and 24 RPM, with feed rates of approximately 15, 10 an 7 g/min, corresponding to shear rates of approximately of 425, 280, and 200 s⁻¹ In each case, the pressure was allowed to stabilize before measurements were recorded. To allow direct comparison between the samples and the baseline, the following procedure was used. The shear stress was plotted vs. the shear rate and a power law regression was calculated. From the regression curve, the shear stress at the exact shear rate of 400 s⁻¹ was calculated. Using this technique, a shear stress of 264 kPa was obtained. The extrudate was white.

### Comparative Example 1

Using the same condition used for the baseline, a blend containing 99% of T-2 and 1% of PA-1 was feed to the extruder. Sufficient time was allowed for the PA-1 to coat the die before the measurements were made. From the power law regression, the shear stress was 291 kPa. The extrudate was black, due to a reaction between the amines of the T-2 and PA-1.

### Example 1

Example 1 was conducted in a similar fashion to comparative Example 11, except that PA-1 was replaced with PA-2. In this case, a shear stress of 241 kPa was obtained and the extrudate was white.

TABLE 1

| Sample | Process Additive | Extrudate color | Shear stress^{a} |
|---|---|---|---|
| EX-1 | PA-2 | White | 241 kPa |
| CE-1 | PA-1 | Black | 291 kPa |

^{a} The shear stress observed for extrusion of T-1 without process additive was 264 kPa.

1. A composition comprising:
from 50 to 99.99 weight percent based on the total weight of the composition of a melt-processable thermoplastic polyamide polymer; and
a silicone-containing polymeric process additive;
wherein the ratio of the silicone-containing polymeric process additive is present in an amount of from 0.01% to 5.0% by weight based on the total weight of the composition.

2. The composition of claim 1, wherein the polyamide polymer is selected from the group consisting of: a polyamide homopolymer, a polyamide co-polymer, and a combination thereof.

3. The composition of claim 1, wherein the polyamide polymer is selected from the group consisting of: an aliphatic polyamide polymer, a semi-aromatic polyamide polymer, and an aromatic polyamide polymer.

4. The composition of claim 3, wherein the polyamide polymer is an aliphatic polyamide polymer.

5. The composition of claim 4, wherein the polyamide polymer is selected from the group consisting of: [NH—(CH₂)₅—CO]ₙ and [NH—(CH₂)₆—NH—CO—(CH₂)₄—CO]ₙ, where n is an integer of from 10 to 10,000.

6. The composition of claim 1, wherein the silicone-containing polymeric process additive is a silicone-polyurethane.

7. The composition of claim 1, wherein the silicone-containing process additive is a silicone-polyamide selected from the group consisting of:
a copolymer comprising at least two repeat units of Formula I: 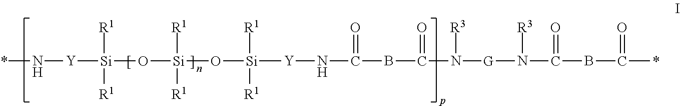
wherein each R¹ is independently selected from the group consisting of: an alkyl group, a haloalkyl group, an aralkyl group, an alkenyl group, an aryl group, an alkoxy group, and a halogen;
each Y is independently selected from the group consisting of: an alkylene group, aralkylene group, and a combination thereof;
G is a divalent group;
each B is independently selected from the group consisting of: a covalent bond, an alkylene group having from 4 to 20 carbons atoms, an aralkylene group, an arylene group, and a combination thereof; n is an integer of 0 to 1500; and p is an integer of 1 to 10; and
each R³ is independently selected from the group consisting of: an alkyl group, a haloalkyl group, an aralkyl group, an alkenyl group, an aryl group, an alkoxy group, and an alkylene group having 2 or more carbon atoms forming a heterocyclic ring that includes the R³ groups, the nitrogen atoms, and G.

8. The composition of claim 1, wherein the silicone-containing process additive is present in a weight percent of from 0.01 wt % to 3.0 wt % based on the total weight of the composition.

9. The composition of claim 1, wherein the silicone-containing process additive is present in a weight percent of from 0.01 wt % to 0.5 wt % based on the total weight of the composition.

10. The composition of claim 1, further comprising a synergist.

11. The composition of claim 10, wherein the synergist is selected from the group consisting of i) a silicone-polyether copolymer; ii) an aliphatic polyester; iii) an aromatic polyester; iv) a polyether polyol; v) an amine oxide; vi) a carboxylic acid; vii) a fatty acid ester; and vii) a poly(oxyalkylene) polymer.

12. The composition of claim 11, wherein the synergist is polyethyleneglycol.

13. The composition of claim 10, wherein the synergist is present in an amount of from 10 wt % to 75 wt % based on the total weight of the synergist and the process additive.

14. The composition of claim 1, further comprising an anti-static additive.
